(19) United States
(12) Patent Application Publication
(10) Pub. No.: US 2015/0071581 A1
(43) Pub. Date: Mar. 12, 2015

(54) PREASSEMBLED INSERTABLE ROLLER BEARING UNIT

(71) Applicant: Schaeffler Technologies GmbH & Co. KG, Herzogenaurach (DE)

(72) Inventor: Alexander Gieser, Niederwerrn (DE)

(21) Appl. No.: 14/386,200

(22) PCT Filed: Mar. 18, 2013
(86) PCT No.: PCT/EP2013/055508

§ 371 Date: Sep. 18, 2014

(30) Foreign Application Priority Data
Apr. 23, 2012 (DE) DE102012206659.4

(51) Int. Cl. F16C 41/04; F16C 19/36

(52) U.S. Cl. CPC F16C 41/045; F16C 19/364
USPC 384/559

(57) ABSTRACT

A preassembled insertable roller bearing unit, especially a tapered roller bearing unit, including an outer ring (1), an inner ring (2) and rolling elements (3) that can roll between the rings in a load-bearing manner. In the preassembled state of the roller bearing unit, two ring elements (5, 6) that are opposite from each other at the axial ends of the roller bearing unit are each in contact with the outer ring (1) as well with the inner ring (2), and one contact is released per ring element (5, 6) when the roller bearing unit is used for the first time. The resultant gap seals exhibit such a good sealing effect that it is even possible to dispense with all sealing lips.

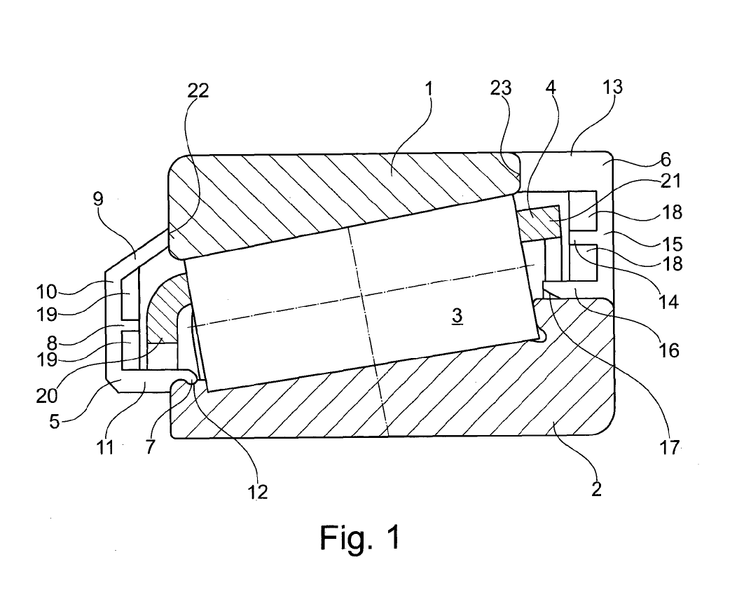

The invention relates to a preassembled insertable roller bearing unit, especially to a tapered roller bearing unit, comprising an outer ring, an inner ring and rolling elements that can roll between the rings in a load-bearing manner.

### BACKGROUND

Preassembled insertable roller bearing units, especially wheel bearing units, that are intended, for example, for utility vehicles, are used whenever a proper installation of a wheel bearing—as a rule, consisting of at least two wheel bearing units—cannot be carried out in a car repair shop.

The proper installation of a wheel bearing necessarily calls for a clean working environment and numerous precautionary measures. Unfortunately, however, these measures cannot be followed under extreme conditions such as, for example, in a desert environment. Dirt in the roller cavity usually has a detrimental effect on the service life of the wheel bearing. The same problem is encountered with other types of bearings, particularly in the automotive sector.

It is conceivable to employ replaceable wheel bearing units whose roller cavity does not have to be opened during the installation, thus preventing the risk of dirt getting into the roller cavity. Here, however, the material requirements are relatively high, which makes the wheel bearing expensive and also gives rise to transportation problems. Moreover, it is also a drawback that the wheel hub has to be exchanged every time the wheel bearing is replaced.

For this reason, so-called insert wheel bearing units, especially insert tapered roller bearing units, were developed in the past which can be delivered and transported in a preassembled state, without the need to unnecessarily open up the roller cavity during installation or for some other reason. The insert wheel bearing units, in their preassembled state, are inserted sideways into the wheel carrier, or else inserted into or pressed onto the wheel hub.

Such an insert wheel bearing unit is disclosed in international patent application WO 2007/115 539 A1. Together, two of these insert tapered roller bearing units form a double-row wheel bearing for a utility vehicle.

### SUMMARY OF THE INVENTION

In contrast to the outer rings of conventional wheel bearing units, the outer rings of insert wheel bearing units have a relatively large axial width, so that a sealing assembly located between the outer ring and the inner ring seals off the roller cavity, even during transportation. In addition, at least one holding ring is provided on the axially opposite side, and this ring holds the inner ring and the outer ring in the proper position with respect to each other in the single-row wheel bearing unit. At the same time, this ensures that, thanks to the optimal position of the two bearing rings with respect to each other, the sealing assembly can provide optimal sealing.

Conventional wheel bearing units are normally delivered without an inserted sealing assembly, which is why they do not need an axially widened outer ring. Since these wheel bearing units are usually mounted in a car repair shop under optimal installation conditions, it is completely sufficient for transportation purposes if appropriate packaging, for instance, shrink-wrapping with plastic, is employed.

Manufacturers of roller bearing units are faced with the problem that they have to keep not only these normal wheel bearing units but also the above-mentioned insert wheel bearing units in stock for their customers. In addition, at least two different types of outer rings have to be produced and kept in stock, which gives rise to high costs, particularly in view of the precision requirements involved with producing this component.

It is an objective of the invention to provide, on the basis of the components of conventional roller bearing units, so-called insert roller bearing units that can be created in the most cost-effective manner possible.

The present invention provides a roller bearing unit of the above-mentioned type in that, in the preassembled state of the roller bearing unit, two ring elements that are opposite from each other at the axial ends of the roller bearing unit are each in contact with the outer ring as well with the inner ring, and one contact is released per ring element when the roller bearing unit is used for the first time.

The term “preassembled insertable roller bearing unit” refers to a single-row roller bearing unit or to a multiple-row roller bearing unit whose components are arranged in a self-locking manner with respect to each other as is the case during operation. Therefore, the roller bearing unit can be handled, transported and installed as a whole. The pre-lubricated (for instance, with grease) roller cavity containing the rolling elements does not have to be opened at any point in time. The terms “outer ring” and “inner ring” refer to bearing rings which contain the races for the rolling elements or which can be indirectly connected to components having such rolling elements. Roller bearings roll between the outer ring and the inner ring in a load-bearing manner.

According to the invention, in the preassembled state of the roller bearing unit, two ring elements that are opposite from each other at the axial ends of the roller bearing unit are each in contact with the outer ring as well with the inner ring. This ensures that the roller bearing unit is sealed, so that its interior is protected against dirt getting into it during transportation. Advantageously, it is possible to dispense with sealing assemblies such as, for instance, cartridge seals having various types of sealing lips.

When the roller bearing unit is used for the first time, one contact is released per ring element when the outer ring is rotated relative to the inner ring. The released contact ensures sealing only during transportation. However, since two contacts are not released until the time of the first use, the installation environment, an axle pivot, a wheel carrier, a wheel hub or the like, can now all compensate for the sealing loss or for the loss of two sealing contacts. In particular, sealing lips are no longer necessary.

The release can be effectuated by a slight material abrasion on the ring elements, which are advantageously made of plastic, whereby this also leads to an extremely narrow sealing gap. The abraded material is so negligibly small that the lubricant can easily absorb it, even if it has not already been carried to the outside anyway. In other words, the releasing process converts the released contact between the ring element and the inner or outer ring into a sealing gap or sealing labyrinth.

Advantageously, both released contacts are formed by two adjoining axial surfaces, conical surfaces or cylindrical ring surfaces. As a result, a sealing gap can be advantageously configured or positioned, or else a certain structural simplicity is attained for the roller bearing assembly.

The ring elements can be a radially inner ring element and a radially outer ring element. As a result, the roller bearing unit lends itself very well for tapered roller bearings whose races ascend in the axial direction.

In an advantageous embodiment, one of the two ring elements or else both of the ring elements surround one end of the roller bearing cage radially on the outside. This allows the construction of an axially narrow roller bearing unit that can employ the roller bearing steel almost exclusively for the race width, thus attaining cost benefits. Accordingly, one of the two ring elements or else both of the ring elements are surrounded by one end of the roller bearing cage radially on the outside, which also has a positive impact on the installation space since sufficient space can be obtained for the attachment, in spite of a very short bearing ring.

A further reduction of the installation space is achieved if one end of the roller bearing cage located radially on the inside or else if one end of the roller bearing cage located radially on the outside forms a gap with the appertaining ring element, especially with a rib shaped onto the appertaining ring element. In this manner, the space that conventional bearings normally occupy for cartridge seals can be used for grease pockets, thereby further improving the service life of the roller bearing unit.

Both of the ring elements have an attachment piece for attaching the appertaining ring element on the inner ring or on the outer ring. This determines with which ring each appertaining ring element moves along, or with which ring the appertaining ring element remains stationary.

Preferably, the radially inner ring element is attached by a positive or by a friction fit between its attachment piece and the inner ring. In this manner, the inner ring element can simply be snapped in place, whereby a press fit or a positive fit can be implemented when it is snapped on. In this context, the snap-on mechanism can extend in the circumferential direction, or else it can act on one or more points along the circumference. It is accordingly advantageous that the radial outer ring element can be attached by a positive fit or by a friction fit between its attachment piece and the inner ring.

There can be a first contact that is released between the outer ring and a contact piece of the radially outer ring element. This contact can advantageously be situated in the opening or hole, especially in the wheel hub of a utility vehicle, as a result of which the gap opening created there is radially surrounded on the outside, thereby being additionally protected against the penetration of dirt. There can be a second contact that is released between the outer ring and the contact piece of the radially inner ring element. In this manner, it would likewise be possible to place this contact in the receptacle of the outer ring and there would be no need for it to be open in the axial direction.

In an advantageous embodiment, one of the ring elements or both of the ring elements form at least one grease pocket in the interior, especially by means of the shaped-on rib. The installation space that is normally employed for sealing assemblies is now available to receive lubricant, whereby one or more ribs can provide the requisite number of pockets along the circumference.

The process of inserting the roller bearing unit according to the invention can also be facilitated in that the attachment piece of the radially outer ring element is designed to transmit axial insertion forces onto the outer ring when the roller bearing unit is being inserted into its operating position. Therefore, its material has to be, on the one hand, soft enough for a contact that is released and, on the other hand, it has to be able to withstand the insertion force and to transmit it in the axial direction.

Advantageously, two single-row roller bearing units according to the invention are combined to form a replacement set, thereby making it possible to form double-row angular-contact bearing assemblies, or else to replace them employing the prior-art method.

Other advantageous embodiments and preferred refinements of the invention can be gleaned from the figure description and/or from the subordinate claims.

### BRIEF DESCRIPTION OF THE DRAWING

The FIGURE shows a tapered roller bearing version of the roller bearing unit in a cutout view along the rotational axis.

### DETAILED DESCRIPTION

The ring element 5 is a holding element since, by virtue of the positive fit, the holding tab 7 is axially secured in the groove 12 of the inner ring 2, and thus, via the contact piece 9, it can also hold the outer ring 9 in the proper position and especially can clamp the outer ring 9 between itself and the ring element 6. As an alternative or in addition, the contact piece 9 can also be employed to brace the outer ring 1 against the rolling elements 3.

The disk ring 10 constitutes a good axial contact surface onto which the wheel bearing unit can be axially placed onto a plane such as, for example, in a transportation box. The attachment piece 11 with the holding tab 7 as well the contact piece 9—which together form the ring element 5—can be arranged on the disk ring 10, thus covering an axial side of the wheel bearing unit and also sealing it off statically before it is used for the first time.

When complicated structures are involved, the ring element 5, 6 can also consist of several parts that are then not produced together, for instance, injection-molded, but rather separately from each other, and are only assembled during the installation.

The rib 8 has an annular shape and it forms two radially arranged grease pockets 19.

In a longitudinal sectional view, the ring element 5 has the shape of a C and it encircles the cage end 20. In this manner, the cage end 20 is protected without the need for it to be completely surrounded by the bearing rings 1, 2.

Together with the counterpart of the contact piece 9, the axial end face 19 of the outer ring 1 forms a contact that is released. When the wheel bearing of a truck is involved, then the outer ring 1 would rotate and the inner ring 2 would be stationary. With this, both ring elements 5, 6 also remain stationary. The ring element 6 has a slightly smaller outer radius than the outer ring 1, as a result of which it can form a cylindrical gap together with the receptacle (not shown here) of the wheel hub, and this gap serves as a sealing labyrinth, thereby making a sealing lip superfluous.

The other contact that is released is formed by the axial end face 20 of the outer ring 1 and its counterpart on the ring element 6. In a longitudinal sectional view, the ring element 6 has the shape of an E which, by virtue of the typical rim of tapered roller bearings, lends itself for the realization of a cylindrical press fit. Here, too, instead of a cartridge seal, it is possible to implement two ring-shaped grease pockets 18 that are separated from each other by the rib 14.

The attachment piece 13 has the same radial thickness as the outer ring 1 on the end face 20. In this manner, the maximum possible insertion surface is axially brought closer to the insertion tool (not shown here), as a result of which the material of the ring element 6 can be selected to be as soft as possible so that it will abrade easily during the release, without jeopardizing the structural integrity of the ring element 6.

Advantageously, the ring element 6 can take over the function of the insertion tool, so that the latter no longer has to be included as a separate part in the delivery. Consequently, the ring element 6 can be joined directly to the source of force without the need to arrange another auxiliary means in the force path. For instance, the ring element 6 could have structural reinforcement ribs that run neither in the radial nor in the circumferential direction.

In summary, the invention relates to a preassembled insertable roller bearing unit, especially a tapered roller bearing unit, comprising an outer ring 1, an inner ring 2 and rolling elements 3 that can roll between the rings in a load-bearing manner. The objective is to refine the prior-art insert roller bearing units in order to attain additional cost savings and production advantages. For this purpose, it is proposed that, in the preassembled state of the roller bearing unit, two ring elements 5, 6 that are opposite from each other at the axial ends of the roller bearing unit are each in contact with the outer ring 1 as well with the inner ring 2, and one contact is released per ring element 5, 6 when the roller bearing unit is used for the first time. The resultant gap seals exhibit such a good sealing effect that it is even possible to dispense with all sealing lips.

### LIST OF REFERENCE NUMERALS

1 outer ring
2 inner ring
3 tapered roller
4 roller bearing cage
5 radial inner ring element
6 radial outer ring element
7 holding tab
8 rib
9 contact piece
10 disk ring
11 cylindrical attachment piece
12 groove
13 contact piece
14 rib
15 disk ring
16 cylindrical attachment piece
17 bevel
18 grease pockets
19 grease pockets
20 radial inner cage end
21 radial outer cage end
22 axial end face
23 axial end face

What is claimed is:

1-13. (canceled)

14. A preassembled insertable roller bearing unit comprising:
an outer ring;
an inner ring; and
rolling elements rollable between the rings in a load-bearing manner, and in the preassembled state of the roller bearing unit, two ring elements are opposite from each other at the axial ends of the roller bearing unit and are each in contact with the outer ring as well with the inner ring, and one contact is released per ring element when the roller bearing unit is used for the first time.

15. The roller bearing unit as recited in claim 14 wherein the released contacts are formed by two adjoining axial surfaces, conical surfaces or cylindrical ring surfaces.

16. The roller bearing unit as recited in claim 14 wherein the ring elements are a radially inner ring element and a radially outer ring element.

17. The roller bearing unit as recited in claim 14 wherein one of the two ring elements or else both of the ring elements surround one end of a roller bearing cage radially on the outside.

18. The roller bearing unit as recited in claim 14 wherein one of the two ring elements or else both of the ring elements are surrounded by one end of the roller bearing cage radially on the outside.

19. The roller bearing unit as recited in claim 14 wherein one end of a roller bearing cage located radially on the inside or else one other end of the roller bearing cage located radially on the outside forms a gap with the appertaining ring element.

20. The roller bearing unit as recited in claim 19 wherein the gap is formed with a rib shaped onto the appertaining ring element.

21. The roller bearing unit as recited in claim 14 wherein both of the ring elements have an attachment piece for attaching the appertaining ring element on the inner ring or on the outer ring.

22. The roller bearing unit as recited in claim 21 wherein a radially inner ring element of the ring elements is attached by a positive fit or by a friction fit between its attachment piece and the inner ring.

23. The roller bearing unit as recited in claim 21 wherein a radial outer ring element of the ring elements is attached by a positive fit or by a friction fit between its attachment piece and the inner ring.

24. The roller bearing unit as recited in claim 14 wherein a first contact that is released is between the outer ring and a contact piece of a radially outer ring element of the ring elements.

25. The roller bearing unit as recited in claim 14 wherein a second contact that is released is between the outer ring and a contact piece of a radially inner ring element of the ring elements.

26. The roller bearing unit as recited in claim 14 wherein one of the ring elements or both of the ring elements form at least one grease pocket in the interior.

27. The roller bearing as recited in claim 26 wherein a shaped-on rib of the one ring element or both ring elements forms the at least one grease pocket.

28. The roller bearing unit as recited in claim 14 wherein an attachment piece of a radially outer ring element of the ring elements is designed to transmit axial insertion forces onto the outer ring when the roller bearing unit is being inserted into its operating position.

29. A tapered roller bearing unit comprising the bearing unit as recited in claim 14.
